(19) United States
(12) Patent Application Publication
(10) Pub. No.: US 2005/0201086 A1
(43) Pub. Date: Sep. 15, 2005

(54) Protective light barrier

(75) Inventor: Ralf Friedrich, Buggingen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch (DE)

(21) Appl. No.: 11/075,331

(22) Filed: Mar. 7, 2005

(30) Foreign Application Priority Data
Mar. 11, 2004 (DE) 20 2004 003 810

(51) Int. Cl. F21V 33/00

(52) U.S. Cl. 362/217

(57) ABSTRACT

A housing for use with light barriers which is made from a hollow profile and which has open ends closed by end caps. A transverse web on the inside of the housing has a borehole which is aligned with a corresponding borehole in a flange that extends inwardly into the housing from an inside of the end cap(s). A locking pin can be inserted from a longitudinal side of the housing and is seated in the boreholes, thereby securing the end cap to the housing. The longitudinal side of the housing is preferably the light exit and/or entry side for light of the light barrier and overlies the locking pin. The locking pin is dimensioned so that a light-transparent cover placed over the housing opening keeps the locking pin in its locking position.

### BACKGROUND OF THE INVENTION

The invention concerns a protective mechanism, in particular a light barrier or light grid, with at least one light emitter unit and/or one light receiver unit in a housing configured as a hollow profile that is closed at one end by an end cap.

Such light grids are used to monitor access or protected zones, for example, near dangerous machines.

Known light grids of this type work on the basis of either the one-way principle or the reflection principle. In the one-way principle, the light emitter unit is arranged in a first housing on one side of a protected zone to be monitored. The light receiver unit is located in a second housing on the opposite side of the protected zone. In the light emitter unit are one or more light emitters, which communicate with one or more light receivers in the light receiver unit.

In light grids using the reflection principle, the light emitter unit and the light receiver unit are both installed in a housing on one side of the protected zone. The light from the light emitter unit is reflected back by a reflector unit at the end of the protected zone and is therefore also directed to the light receiver unit.

The term “light” as used in this application is not limited to visible light. “Light” therefore includes all electromagnetic rays that are customarily used for the operation of light barriers and light grids, i.e. from UV light through the visible range to IR light.

The number of light beams passing through the protected zone and the distance between the light beams of such light grids vary in accordance with the task. This means that relatively large variations occur with respect to the length of the light grid housing. It is known to fabricate such light grid housings as a hollow profile, which can be produced, for example, by injection molding. The required length is cut from a hollow profile that is typically several meters in length and is closed at both ends with special caps.

A disadvantage of such prior art light grid housings is that the hollow profile requires the use of up to four screws to properly attach the end caps to both ends of the housing. This involves a time-consuming and costly assembly process. The reason for this is not only the cost of the screws, but also the fact that the entire assembly process must be performed in various directions and on several sides of the work piece. For large light grids, this generally requires costly assembly jigs, clamping mechanisms, torqueing the screws, etc.

### SUMMARY OF THE INVENTION

It is therefore an object of the present invention to connect the end caps to the hollow housing profile in a simple and cost-effective manner so that the assembly process can be done from the same longitudinal side of the hollow profile that is also used for installing the electrical, optical and mechanical components of the light grid. This is accomplished by providing a connection between the end cap and the housing that can be accessed from a longitudinal side of the hollow housing.

An advantage of the light grid of the present invention is that the connection between the end cap and the housing can be set and released from one of the longitudinal sides of the hollow housing profile. The tooling can be the same as that for installing the electrical, optical and mechanical components of the light grid, which saves substantial time and costs.

In a preferred embodiment, the connection is configured as a cylindrical locking pin which can have a frusto-conical tip. This has the advantage over a screw connection, for example, that no threaded holes are required in the hollow profile and/or the end cap. Instead, only cylindrical positioning boreholes and only a linear movement of the pin are necessary to place (or remove) the locking pin, which, when desired, can be done with the help of a simple cylinder actuator.

An advantageous modification of the invention uses the light exit and/or light entrance side of the hollow profile to both install the light grid components and extend the connector into the housing for securing the end caps on the hollow profile. Since one of the longitudinal sides of the hollow housing is necessarily covered by a separate, optically transparent glass plate in order for the light grid to operate, no additional opening is needed in the hollow profile for introducing the connector, which has a positive impact on the production costs of the light grid.

According to another embodiment of the invention, the connector, e.g. the locking pin, is dimensioned so that it is secured in its locking position by the glass cover plate when the latter is mounted on the hollow housing. As a result, even when the light grid is used under harsh environmental conditions, which may, for example, include impact and vibrations, the locking pin will remain in its locking position. With such a configuration of the locking pin, additional securing measures, such as the application of a safety lacquer or the like, become superfluous.

One variant of the invention that is particularly economical connects the locking pin to the part enclosing the longitudinal side, e.g. the glass cover plate. This embodiment requires only one assembly step, namely closing the cover plate to thereby also secure the end cap(s) to the hollow profile of the housing.

In a convenient modification of the invention, at least one of the end caps of the light grid is configured to provide an electrical connection space for the light grid to the interior of the housing. This has the advantage that the connection unit for the electrical power supply and the data lines are arranged on the light grid housing simultaneously with securing the end caps to the hollow housing profile without requiring additional assembly efforts, tools, etc.

### BRIEF DESCRIPTION OF THE DRAWINGS

FIG. 1 is a perspective view of a light grid housing constructed in accordance with the invention;

FIG. 2 is a cross-section through the light grid housing and is taken along line A-A of FIG. 1; and

FIG. 3 is a perspective, exploded view of the light grid housing, with parts broken away.

### DESCRIPTION OF THE PREFERRED EMBODIMENTS

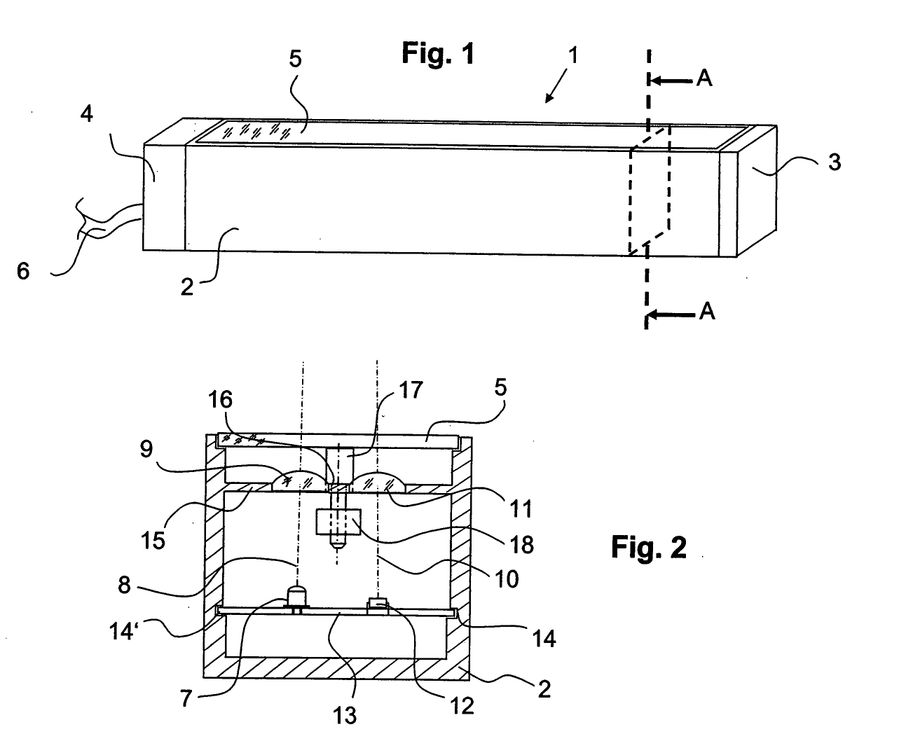

FIG. 1 shows a light grid housing 1 that has a hollow profile 2. At the ends of the housing are two removable end caps 3 and 4 for closing the interior of the housing from the exterior. One longitudinal side of the hollow profile housing 2 is closed by a glass cover plate 5. In the drawings, this side is shown as the upper side of the housing. Since cover plate 5 on the longitudinal side of the hollow profile 2 is used as the light exit and/or entrance side of the light of the grid, the cover plate is made of an optical material having a high optical transparency to the light used by the light grid. An electrical power supply and a data line 6 needed for the operation of the light grid extends through end cap 4.

FIG. 2 shows, in a cross-section taken along line A-A in FIG. 1, hollow profile 2 as well as a light emitter unit and light receiver unit. The light emitter unit includes a light emitter 7 and a transmission optic 9 arranged on an optical transmission axis 8. In an analogous manner, receiving optics 11 and a light receiver 12 are arranged along an optical reception axis 10. The light from light emitter 7 propagates in a direction determined by transmission optic 9 and emerges from the hollow profile in the region of the transmission axis 8 through cover plate 5. Likewise, reception optic 11 receives light impinging in the region about the reception axis 10 and focuses the light on light receiver 12.

Light emitter 7 and light receiver 12 are mounted along with other electrical components on a circuit board 13. The circuit board is held by two grooves 14 and 14′ in hollow profile 2. A web 15 is arranged in the hollow profile 2 parallel to and spaced apart from cover plate 5. Web 15 includes apertures which hold and position transmission optics 9 and reception optics 11.

In the immediate vicinity of the end of hollow housing profile 2 is a positioning borehole 16 that extends through a web 15 into which a locking pin 17 can be inserted. The positioning borehole 16 in web 15 is aligned with a locking flange 18 extending inwardly from the inner side of end cap 4 into the hollow housing profile 2. The end cap 4 is secured to the hollow housing profile 2 with locking pin 17.

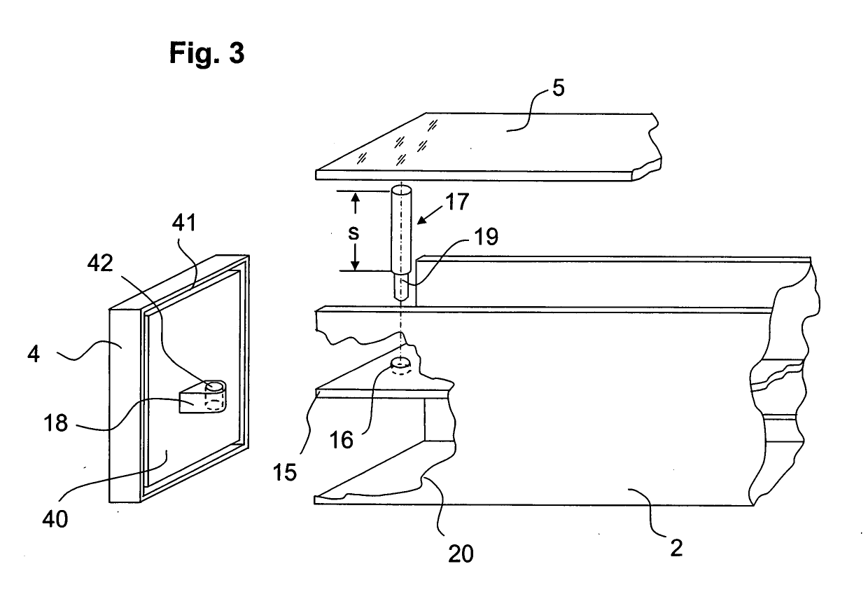

The perspective view of FIG. 3 shows the light grid of the present invention in an exploded view. One side wall of the hollow housing profile 2 is partially broken away in a region 20 to better show borehole 16 in web 15. A circumferential alignment groove 41 on an inside 40 of end cap 4 matches the cross-section of the hollow housing profile 2 so that when the two are joined together, the end cap is form-fitted with and centered relative to the hollow profile. End cap 4 can also be centered relative to hollow profile 2 in other ways, such as, for example, with guiding pegs or centering projections. Locking flange 18 extends into the hollow profile from inside 40 of end cap 4. The locking flange also contains a positioning borehole 42, which is located so that it becomes exactly aligned with positioning borehole 16 in web 15 after the end cap 4 has been centered and joined to the hollow profile.

The cylindrical locking pin 17 has a projection 19 which has a diameter corresponding to that of positioning boreholes 16 and 42 so that the pin can be pushed into both positioning boreholes once end cap 4 has been joined to hollow profile 2. The end of locking pin 17 facing cover plate 5 has a length “s” and a larger diameter than projection 19 of the pin which engages positioning boreholes 16 and 42. This ensures that the locking pin 17 can only be pushed through positioning boreholes 16 and 42 until the shoulder of the locking pin 17 formed by the larger diameter end of the pin contacts web 15.

To secure locking pin 17 in the inserted position, the length s of the larger diameter portion of the locking pin is selected so that the pin extends to just the underside of cover plate 5 when the latter is secured to the housing. Thus, once the cover plate has been secured to the housing, the position of the locking pin is fixed and it will remain in place so that the end cap remains secured to the housing.

It is also possible to permanently arrange the locking pin 17 on cover plate 5. In this configuration, placing the cover plate over the longitudinal opening in the housing simultaneously guides the locking pin into the borehole in flange 18 to thereby lock end cap 4 to the housing in a single work step.

1. A light barrier component comprising an elongated housing having a hollow profile, an opening on a longitudinal side of the housing, the housing being adapted to mount a light emitter unit and/or a light receiver unit inside the housing, an end cap closing an open end of the housing, and a connector which is accessible through the opening in the longitudinal side for securing the end cap to the housing.

2. A light barrier component according to claim 1 wherein the connector comprises a locking pin.

3. A light barrier component according to claim 1 wherein the opening defines a light exit and/or light entrance opening for the housing.

4. A light barrier component according to claim 1 including a cover plate placed over the opening, and wherein the cover plate maintains the connector in its end cap securing position.

5. A light barrier component according to claim 1 wherein the connector is arranged on a cover plate which closes the opening.

6. A light barrier component according to claim 1 wherein the end cap includes space for an electrical connection into an interior of the housing.

7. A housing for use with light barriers comprising a hollow profile having at least one open end, a web extending transversely through at least a portion of the hollow profile close to the open end, the profile having a longitudinal side which is at least partially open, an end cap applied over the open end of the hollow profile including a flange which extends from the end cap into the hollow profile so that the flange and the web overlap, first and second boreholes extending through the web and the flange so that the bores are aligned when the end cap is centered relative to and closes the end of the profile, and a locking pin insertable into an interior of the hollow profile through the opening and disposed in the aligned first and second boreholes which secures the end cap to the profile.
